(19) United States
(12) Patent Application Publication
(10) Pub. No.: US 2026/0361939 A1
(43) Pub. Date: Nov. 12, 2026

(54) CONTENT RECOMMENDATIONS FOR EXTENDED REALITY USERS

(71) Applicant: NeuRealities, Inc., Las Vegas, NV (US)

(72) Inventors: Ivelize Rocha Bernardo, Manchester (GB); Zisis Tsatsas, Salford (GB); Shaun Cook, Farnham (GB); Michael Fagan, Widnes (GB)

(21) Appl. No.: 19/470,160

(22) PCT Filed: Mar. 30, 2023
(86) PCT No.: PCT/GB2023/050831

§ 371 Date: Sep. 29, 2025

(51) Int. Cl. H04N 21/25; G06T 19/00

(52) U.S. Cl. CPC H04N 21/251; G06T 19/006

(57) ABSTRACT

A computing system, method, and computer-readable medium includes an extended reality application and a recommendation model that a host computing system uses to provide an extended reality event to client computing systems. The extended reality application requests a content recommendation from the recommendation model and the recommendation model determines whether a dynamic threshold of user data is satisfied. When the dynamic threshold of user data is not satisfied, a cold start algorithm generates a cold start content recommendation. When the dynamic threshold of user data is satisfied, a preferences algorithm generates a preferences content recommendation.

### TECHNICAL FIELD

Embodiments of the technology relate generally to providing content recommendations for users in an extended reality environment.

### BACKGROUND

Virtual reality, augmented reality, and combinations of the two, collectively referred to as extended reality, are immersive software experiences that can bring people from multiple locations together. Extended reality software applications can provide a large scale immersive virtual reality space to run virtual events. Such XR applications allow participants to exchange ideas, make connections, and interact with various content types, such as on demand videos, documents, and live sessions with other participants. Virtual events reduce the costs and time requirements associated with in-person events and offer a variety of technology-based advantages.

It is typically desirable to offer a variety of content at a virtual event to satisfy a range of attendees and to allow the attendees to customize their agendas at the event. However, providing a large variety of sessions and content at an event can overwhelm the attendees and make it difficult for the attendee to maximize the benefit of attending the event. Accordingly, an approach that provides content recommendations tailored to each attendee at an event can improve the experience and maximize the benefit of attending the event for all attendees. Furthermore, a content recommendation approach that is dynamic so that it adjusts as the interests of the attendees' change would be beneficial.

### SUMMARY

In one example embodiment, a computer-implemented method for a host computing system to provide an extended reality event to a client computing system, wherein the hosting computing system comprises an extended reality application and a recommendation model. The computer-implemented method can comprise: (1) requesting, by the extended reality application from the recommendation model, a content recommendation for a user associated with the client computing system; (2) determining, by the recommendation model, whether a dynamic threshold of user data is satisfied by analyzing user data associated with the user; (3) when the dynamic threshold of user data is not satisfied, executing, by the content recommendation model, a cold start algorithm (e.g., MAB algorithm) that generates a cold start content recommendation, and providing the cold start content recommendation to the extended reality application for delivery to a client computing system associated with the user; and (4) when the dynamic threshold of user data is satisfied, executing, by the content recommendation model, a preferences algorithm (e.g., HMM algorithm) that generates a preferences content recommendation, and providing the preferences content recommendation to the extended reality application for delivery to the client computing system associated with the user.

As will be described further below in the detailed description, in the foregoing method, the user data associated with the user comprises identifying data, schedule data, and prior interactions data. The cold start algorithm generates the cold start content recommendation based upon a popularity of cold start content associated with the cold start content recommendation and based upon a randomizing factor, wherein the randomizing factor mitigates bias in the generation of the cold start content recommendation. The foregoing method can further comprise: (1) receiving, from the client computing system, an acceptance of the cold start content recommendation; (2) delivering, by the extended reality application to the client computing system, the cold start content associated with the cold start content recommendation; and (3) updating, by the extended reality application, the user data to reflect the acceptance and delivery of the cold start content.

In yet another example embodiment of the foregoing method, the preferences algorithm generates the preferences content recommendation based upon an analysis of a sequence of the prior interactions data and a determination of convergence of the prior interactions data.

The foregoing embodiments are non-limiting examples and other aspects and embodiments will be described herein. The foregoing summary is provided to introduce various concepts in a simplified form that are further described below in the detailed description. This summary is not intended to identify required or essential features of the claimed subject matter nor is the summary intended to limit the scope of the claimed subject matter.

### BRIEF DESCRIPTION OF THE DRAWINGS

The accompanying drawings illustrate only example embodiments of a system, method, and computer-readable media for providing a content recommendations for an extended reality environment. Therefore, the examples provided are not to be considered limiting of the scope of this disclosure. The principles illustrated in the example embodiments of the drawings can be applied to alternate methods and apparatus. In the drawings, the same reference numerals used in different embodiments designate like or corresponding, but not necessarily identical, elements.

FIG. 1 illustrates an example of a computing system that provides extended reality event content to users in accordance with an example embodiment of the disclosure.

FIG. 2 illustrates an example of data structures comprising user data in accordance with an example embodiment of the disclosure.

FIG. 3 illustrates an example of data structures comprising extended reality event content in accordance with an example embodiment of the disclosure.

FIG. 4 illustrates an example method for providing extended reality event content recommendations in accordance with an example embodiment of the disclosure.

FIG. 5 illustrates an example method for choosing between a cold start algorithm and a preferences algorithm in accordance with an example embodiment of the disclosure.

FIG. 6 illustrates screen shots providing initial extended reality event content in accordance with an example embodiment of the disclosure.

FIG. 7 illustrates screen shots for providing video and document content in accordance with an example embodiment of the disclosure.

FIG. 8 illustrates screen shots for providing recommended schedule content in accordance with an example embodiment of the disclosure.

FIG. 9 illustrates a screen shot of a live meeting at an extended reality event in accordance with an example embodiment of the disclosure.

FIG. 10 illustrates a screen shot of a live meeting and video content at an extended reality event in accordance with an example embodiment of the disclosure.

### DETAILED DESCRIPTION OF EXAMPLE EMBODIMENTS

The example embodiments discussed herein are directed to systems, methods, and computer-readable media providing extended reality content recommendations in connection with an extended reality event. Past approaches to providing content recommendations typically are simplistic and inflexible. In contrast, the approaches described herein provide a recommendation model that can choose between one of two algorithms to provide extended reality content recommendations. The first algorithm, referred to as the cold start algorithm (e.g., a multi-arm bandit algorithm), can provide content recommendations based upon general popularity of content when little is known about a user, such as at or near the beginning of the event. In contrast, the second algorithm, referred to as the preferences algorithm (e.g., a hidden Markov model algorithm), can provide content recommendations based on a user's previous interactions with content or other participants at the extended reality event. The recommendation model provides a further advantage in that it can be dynamic, meaning it can switch from the first algorithm to the second algorithm as more data is gathered about a user and as the user's preferences change while attending the event.

The example approaches described herein facilitate providing content recommendations that are more likely to meet the interests of the attendees. Accordingly, the example approaches described herein allow attendees to maximize the benefit of attending the extended reality event.

As will be described further in the following examples, the systems, methods, and computer-readable media described herein improve upon existing approaches to providing content recommendations for an extended reality event. The improved approaches described herein can be embodied in a computer system, as a method executed by a computer system, and as a method embodied in a computer-readable medium.

In the following paragraphs, particular embodiments will be described in further detail by way of example with reference to the drawings. In the description, well-known components, methods, and/or processing techniques are omitted or briefly described. Furthermore, reference to various feature(s) of the embodiments is not to suggest that all embodiments must include the referenced feature(s).

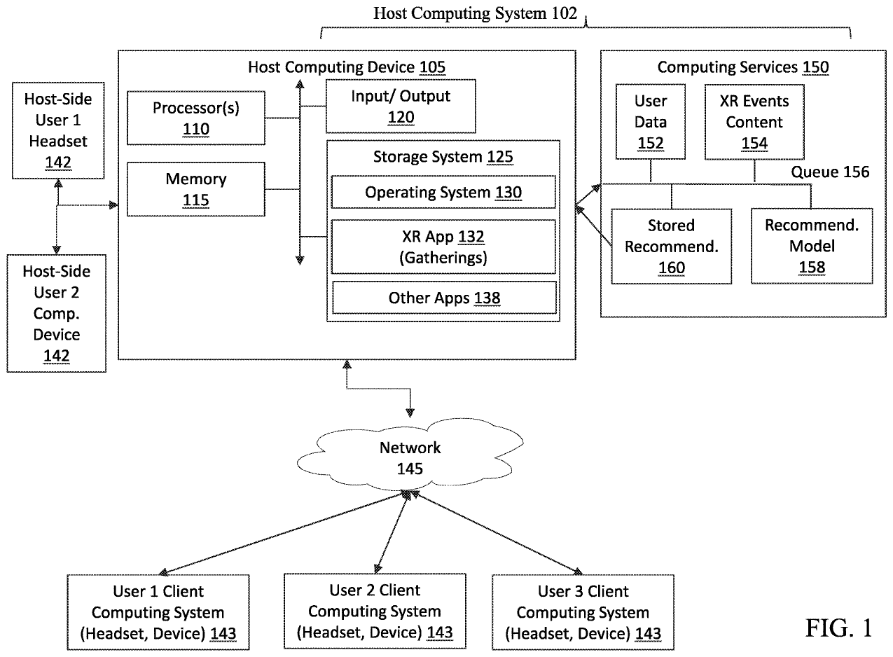

Referring now to FIG. 1, an example system for delivering extended reality content to client computing systems is illustrated. The system shown in FIG. 1 is a non-limiting example that has been simplified to illustrate the improved approaches to delivering extended reality content described herein. It should be understood that in alternate embodiments certain of the computing components illustrated in FIG. 1 can be combined, simplified, or distributed in a different manner. Furthermore, in other embodiments, the system delivering extended reality content in accordance with the approaches described herein can be implemented in a variety of distributed computing environments that call on computing services to perform the methods herein.

In general, extended reality systems involve audiovisual teleconferencing between one or more host computing systems and a plurality of client computing systems. The host computing system provides audiovisual content to the client computing systems and users at the client computing systems interact with the audiovisual content. The audiovisual content typically renders a virtual (or extended reality) environment in which the users can interact using the client computing systems. While not required, the users typically participate in the virtual environment via a visual representation, such as an avatar. Using the client computing systems, the users share information with the host computing system and other client computing systems, where such information can include one or more of images or video of the user's environment, user orientation data, and user motion data describing motions of the user's hand(s), head, and/or body. The client computing devices can include one or combinations of headsets, wearable input devices, mobile computing devices, and personal computing devices that allow the user to share images, video, and orientation and motion data. The host computing system uses the information received from the client computing devices to render the visual representations (e.g., the avatars) of the users in the virtual environment. The host computing system also can show the visual representations moving or performing other actions. In addition to the users participating via the client computing system, other users can participate from the host computing environment, such as via a host-side headset or host-side computing device.

Referring specifically to FIG. 1, a host computing system 102 can comprise a host computing device 105 in communication with a collection of computing services 150. The host computing device 105 includes one or more processors 110, memory 115, and input/output interfaces 120. A storage system 125 can be an integral component of the host computing device 105, as illustrated in FIG. 1, or it can be external to the computing system and distributed in a cloud computing service. In addition to an operating system, the storage device can include an extended reality application 132 that provides audiovisual content rendering a virtual environment and a variety of other applications 138 that support the extended reality application 132. While the extended reality application 132 is illustrated as a software module stored on host computing device 105, in other embodiments the extended reality application 132 can be implemented as a service provided via a distributed computing environment.

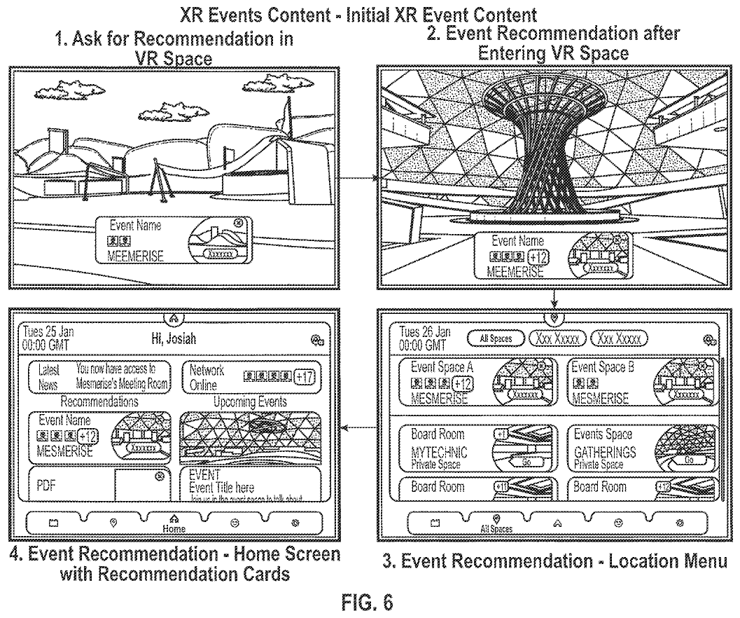

The extended reality application 132 can provide the audiovisual content rendering the virtual environment to a plurality of client computing systems 143 via network 145. Examples of virtual environments are illustrated in FIGS. 6, 9, and 10 and will be described further below. The extended reality application 132 also can receive data, such as the previously described user orientation and motion data, images, and video from client computing systems 143 via network 145. In addition to the client users participating in the virtual environment via client computing systems 143, host-side users can participate in the virtual environment via host-side computing devices 142, such as one or combinations of headsets, wearable input devices, mobile computing devices, and personal computing devices.

The host computing device 105 communicates with the computing services 150 in order to exchange extended reality content and user data, as well as to receive recommendations for extended reality content. The computing services 150 represents a collection of distributed computing resources accessed by the extended reality application 132 via a queue 156. As described further below, extended reality application 132 accesses the computing resources via queue 156 to avoid bottlenecks so that extended reality content recommendations can be regularly updated and provided promptly to the client computing systems.

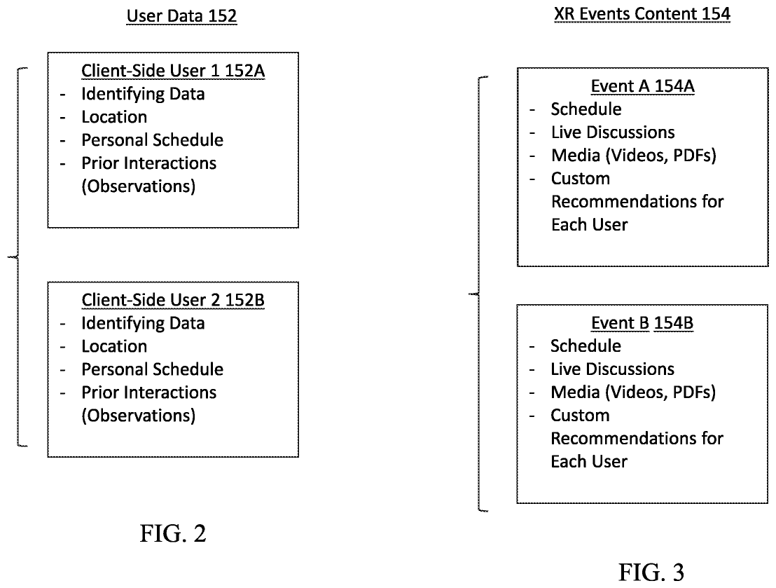

One aspect of the computing services 150 includes one or more databases of user data 152. As illustrated further in FIG. 2, the user data 152 can comprise a data structure for each user participating with the extended reality content. FIG. 2 shows that each data structure for a user can comprise identifying data, location data, personal schedule data, and prior interactions (observations) data. As examples, the identifying data can include a name, email address, and professional or personal information that can be useful in identifying extended reality content that may be of interest to the user. The location data can be a business or personal address or other geographic information. The personal schedule information can be information available from the user's electronic calendar, which can be used in providing a proposed schedule of recommended extended reality content. Lastly, the prior interactions data comprises data relating to the user's prior interactions with one or more extended reality environments and/or content. For example, prior interactions data can include extended reality content selected by the user at a current or previous extended reality event as well as data relating to whether the content was fully consumed and whether the user provided any feedback concerning the content. A user's interactions with extended reality content from current or previous extended reality events can be regularly gathered from the client computing systems via network 145 and stored in the databases of user data 152.

Another aspect of the computing services 150 includes one or more databases of extended reality event content. As one example, an extended reality event can be virtual conference offering a variety of programs and audiovisual content that may be of interest to users. As illustrated further in FIG. 3, extended reality events A and B can each have unique associated content. Each of extended reality events A and B have an associated schedule and associated programs or content in the form of live discussions and audiovisual media. Large virtual conferences often offer an overwhelming amount of programs and content making it difficult for a user to select programs and content that will be of value and interest to the user.

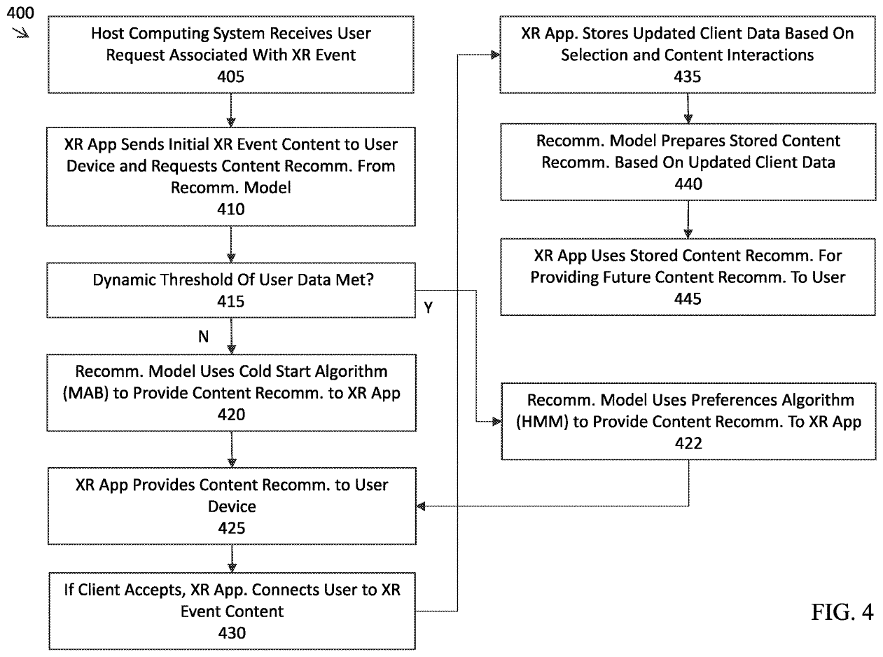

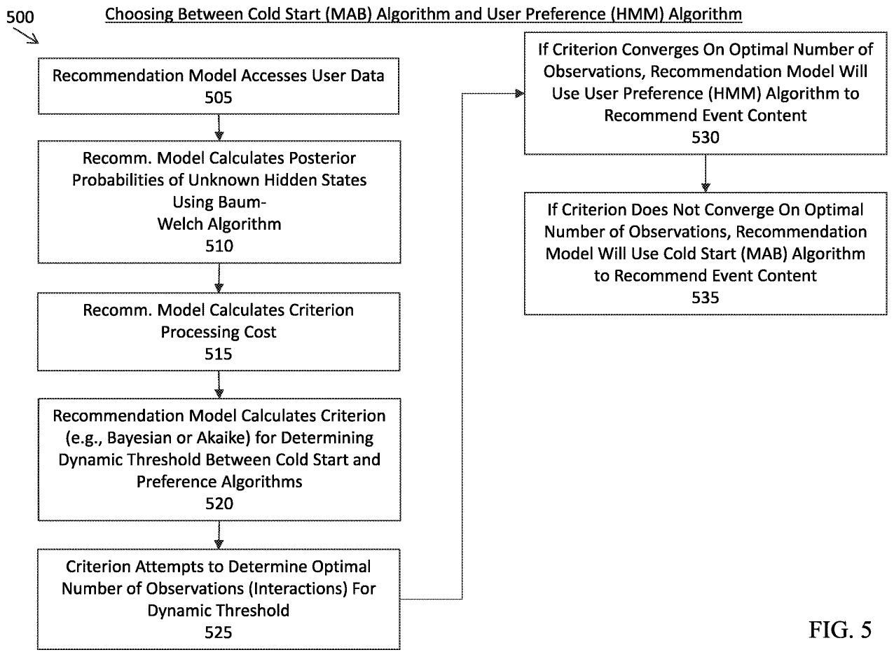

The recommendation model 158 is another aspect of the computing services 150 that can assist users in identifying the extended reality content that will be of value and interest. As will be described further below in connection with FIGS. 4 and 5, the recommendation model comprises the cold start algorithm and the preferences algorithm for predicting content that will be of interest and value to users. The recommendation model utilizes the user data 152 for determining which algorithm to use in making content recommendations and the selection of the algorithm can be adjusted dynamically as more user data becomes available. Extended reality content recommended using the cold start algorithm can be referred to as cold start content, whereas extended reality content recommended using the preferences algorithm can be referred to as preferences content.

Lastly, the computing services 150 also includes one or more databases of stored content recommendations 160 generated from the recommendation model 158. The stored content recommendation 160 can include cold start content recommendations for users where a relatively small amount of user data is available and can include preferences content recommendations for those users where a sufficient amount of user data is available for the preferences algorithm. As illustrated in FIG. 3, stored content recommendations can be organized by each user attending a particular extended reality event and linked to that event. The recommendation model 158 can regularly update the stored content recommendations as new user data becomes available allowing the accuracy of recommendations to be improved. Additionally, the cold start algorithm and the preferences algorithm can be implemented as machine learning algorithms that are trained and improved as new user data becomes available.

Referring now to FIG. 4, an example method 400 is illustrated for providing extended reality content recommendations. Method 400 will be described with reference to the components and features illustrated in the other figures. In alternate example embodiments, one or more of the operations illustrated in FIG. 4 can be modified, performed in parallel, or performed in a different sequence. Furthermore, in alternate embodiments, other operations may be added to the method of FIG. 4.

FIG. 4 illustrates a method for choosing between two algorithms, a cold start algorithm and a preferences algorithm, for providing an extended reality content recommendation. A cold start algorithm can be implemented as a multi-armed bandit (“MAB”) algorithm. As is generally understood, a MAB algorithm can allocate a resource between competing choices in order maximize the expected gain. Each choice (in this case, the extended reality content) provides a random reward from a probability distribution specific to that choice. In contrast, a preferences algorithm can be implemented as a hidden Markov model (“HMM”) algorithm. An HMM algorithm is a statistical model that examines an available sequence of data to predict a sequence of unknown variables. In the examples provided herein, the HMM algorithm uses the sequential behavior of the users as shown in the user data to detect changes in user preferences. This ability to detect changes in user preferences in the sequential user data allows the HMM algorithm to dynamically adjust content recommendations as new user data becomes available and as user preferences change as indicated in the new user data.

Beginning with operation 405, the host computing system 102 receives a user request associated with an extended reality event such as a virtual conference. The user request may be in the form of registration information the user provided when registering for the extended reality event. In operation 410, in response to the user request, the extend reality application 132 can retrieve initial extended reality event content from the extended reality events content database 154 and can provide the initial extended reality event content to the client computing system associated with user. The initial extended reality event content can be generic content provided to all attendees of the event such as the introductory virtual spaces illustrated in FIG. 6. As shown in FIG. 6, the initial extended reality event content can include a location menu identifying spaces within the virtual environment and a home screen that will be populated with extended reality content recommendations. In parallel with providing the initial extended reality event content to the client computing system, the extended reality application 132 also requests a content recommendation for the user from the recommendation model 158.

In operation 415, the recommendation model 158 determines whether a dynamic threshold of user data has been satisfied by analyzing the user data 152 stored for user associated with the user request. Further details describing the determination as it relates to the dynamic threshold of user data are provided below in the description in connection with FIG. 5.

If the dynamic threshold has not been satisfied, in other words, there is insufficient user data, the recommendation model 158 uses a cold start algorithm to make content recommendations in operation 420. Situations where there may be insufficient user data include at or near the beginning of the extended reality event when there have been few interactions by the user with the extended reality event content or if the user has not participated in previous extended reality events that would supply user interaction data. An example of a cold start algorithm is a multi-arm bandit algorithm. The cold start algorithm relies primarily on the general popularity of extended reality content across many users to make a cold start content recommendation. The cold start algorithm also can include a randomization factor in its content selections in order to mitigate any bias in the popularity data. The cold start algorithm, while lacking a sophisticated analysis based upon a large sample of user data, is advantageous in that it is efficient from a processing cost perspective. Therefore, cold start content recommendations can be generated relatively quickly and efficiently without causing bottlenecks in the host computing system 102.

In contrast, the preferences algorithm as represented in operation 422, has higher relative processing costs in that it requires a more sophisticated analysis of a larger sample of user data. Where a sufficient amount of user data 152 is available for the user initiating the request, method 400 proceeds to operation 422 where the recommendation model uses the preferences algorithm to analyze the user data and provide a preferences content recommendation to the extended reality application 132. An example of a preferences algorithm is a hidden Markov model.

The benefit of the dynamic threshold referenced in operation 415 is that it balances the benefits and costs of the more sophisticated preferences algorithm against the benefits and costs of the less sophisticated cold start algorithm. Optionally, in connection with operations 420 and 422, once the recommendation model 158 chooses between the cold start and preferences algorithms, the recommendation model 158 can determine whether cold start content recommendations or preferences recommendations have already been stored in the stored recommendations database 160. If such content recommendations have already been created and stored in the stored recommendations database 160, the recommendation model can select the recommendation created in accordance with the algorithm that was selected (cold start or preferences) and supply that recommendation to the extended reality application 132.

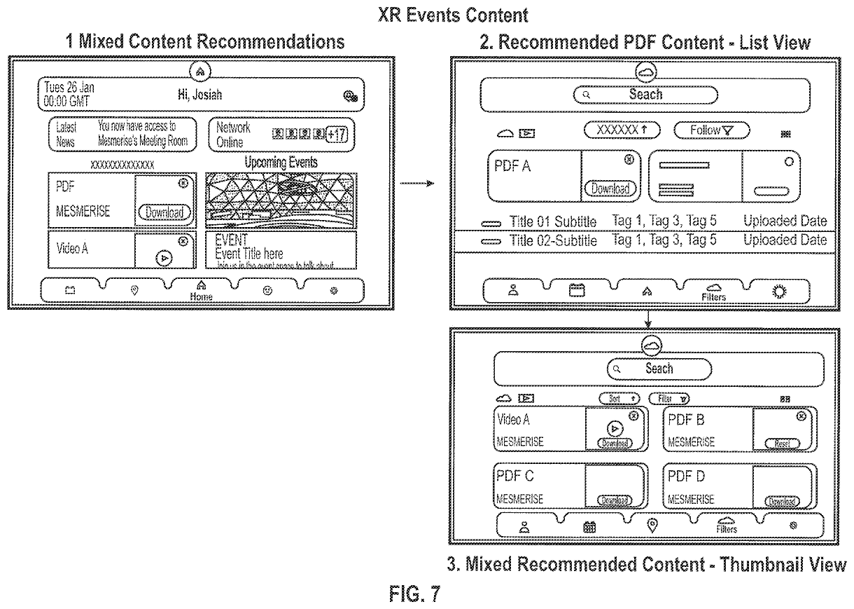

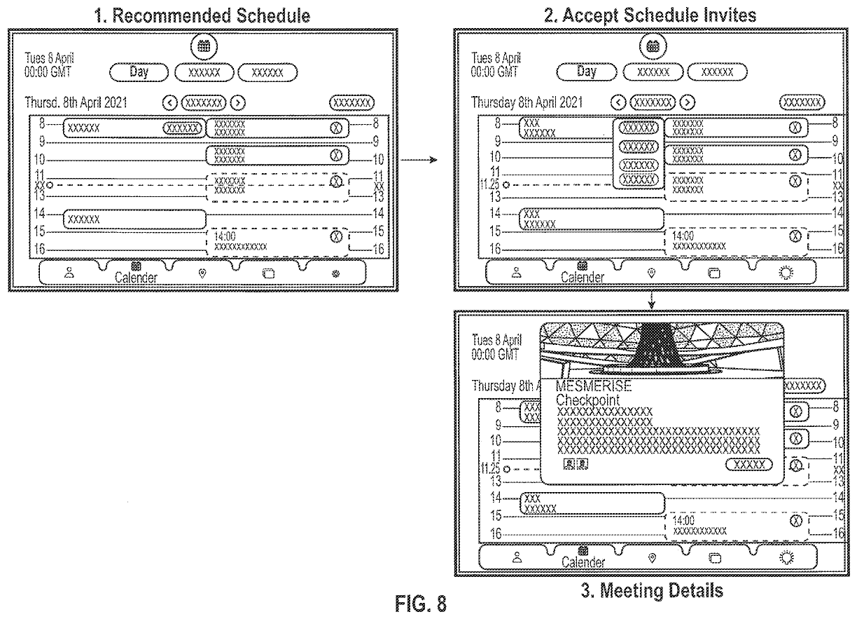

In operation 425, the extended reality application 132 provides the extended reality content recommendation received from the recommendation model to the user's client computing system. Examples of a user interface providing recommended content to a user are illustrated in FIGS. 7 and 8. FIG. 7 illustrates content in the form of videos and PDFs that are associated with the extended reality event. FIG. 8 illustrates an example where the content is recommended in the format of a proposed schedule for the extended reality event. In the example of FIG. 8, the recommendation model's analysis included data from the user's electronic calendar in order to identify content that would suit the user's schedule.

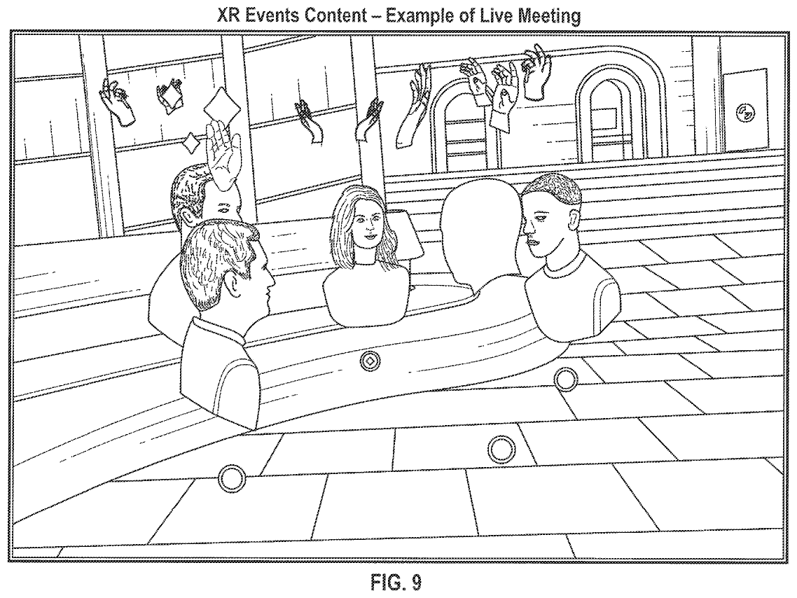

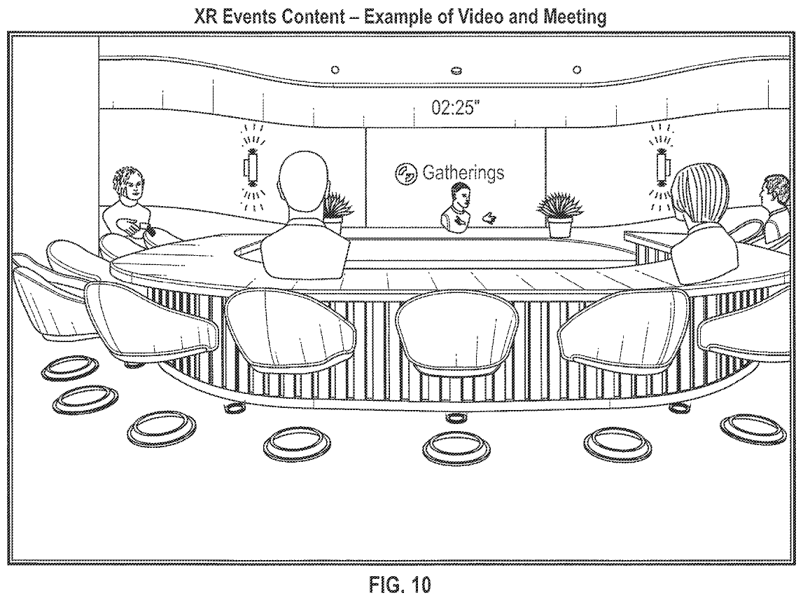

In operation 430, if the client accepts the recommended content, the extended reality application 132 retrieves the content from the extended reality event content database 154 and provides the recommended content to the user's client computing system. In operation 435, the extended reality application 132 gathers data associated with the user's selection of the content and interactions with the content and stores that data in the database of user data 152. FIG. 9 illustrates one example of an extended reality event in which users, represented by their avatars in a live meeting, interact with one another and with content in an extended reality environment. FIG. 10 illustrates another example of an extend reality event in which users, represented by their avatars in a live meeting, interact with one another and video content in an extended reality environment. As more user data is collected and stored for a user, the recommendation model will have more data upon which to make improved content recommendations for the user during the extended reality event and for future events.

In operation 440, the recommendation model can use newly gathered user data stored in the database of user data 152 to prepare additional content recommendations. In connection with operation 440, the recommendation model again makes a determination of whether the dynamic threshold of user data is satisfied similar to that described previously in operation 415 and as described further below in connection with FIG. 5. In operation 445, the extended reality application 132 can access the newly created stored content recommendations in database 160 when future content recommendations are needed for a user.

Referring now to FIG. 5, an example method 500 provides further details concerning the determination of the dynamic threshold referenced in operations 415 and 440 so that the recommendation model can choose between algorithms to provide extended reality content recommendations. In alternate example embodiments, one or more of the operations illustrated in FIG. 5 can be modified, performed in parallel, or performed in a different sequence. Furthermore, in alternate embodiments, other operations may be added to the method of FIG. 5.

Beginning with operation 505, as described previously, the recommendation model 158 accesses the database of user data 152 in order to retrieve relevant user data for preparing a content recommendation. The retrieved user data can include one or more of the user data items illustrated in FIG. 2, such as the user's identifying data, location, personal schedule, and prior interactions. Additionally, the retrieved user data can include more general user data associated with other users, such as the popularity of content and feedback received from users about content.

In operation 510, the recommendation model calculates posterior probabilities of unknown hidden states using the Baum-Welch Algorithm. The Baum-Welch Algorithm is a know expectation-maximization algorithm used to find unknown parameters in a Hidden Markov Model. The recommendation model 158 also selects a criterion for determining a dynamic threshold between the cold start algorithm and the preference algorithm. As examples, the criterion can be an Akaike Information Criterion (“AIC”) or a Bayesian Information Criterion (“BIC”). The criterion is used to find a balance between the number of hidden states in the user data on the one hand and the higher likelihood of accurately predicting content of interest and value to the user on the other hand. The AIC tries to select the model that most adequately describes an unknown, high dimensional reality. Whereas, the BIC tries to find the “true” model among a set of candidates.

Operations 515 and 520 describe one example applying the BIC to select a list of observations (user interactions) to ingest into an HMM algorithm. In operation 515, the BIC considers a processing cost associated with the more sophisticated analysis of the HMM algorithm relative the MAB algorithm and penalizes the quantity of observations, as provided in equation (1) below, and fits the data to the highest likelihood of an accurate prediction with the fewest number of user observations (interactions).

BIC=log(NO)*NS−2*LL (1)

NO is the number of user observations, NS is the number of hidden states in the model, and LL is the log-likelihood of the model. The score as defined above is minimized, e.g. the lower BIC is, the closer the model is to “true”. The recommendation model assigns NO i.i.d. number of observations of user-item interactions defined as X={x₁, x₂, x₃, . . . , X_{NO}}, and M a set of probabilistic models, where each model Mᵢ is defined as Mᵢ=P_{X|θ,M}i(X), where i is the length of NSᵢ, and NSᵢ may differ for each Mᵢ.

Referencing operation 520, the recommendation model 158 calculates the criterion (e.g., Bayesian or Akaike) for determining the dynamic threshold between the cold start algorithm and the preferences algorithm. For large NO, the BIC (equation (1)) selects the model that maximizes the Bayesian posterior probability, which is equivalent to:

M_{B}IC=argmin_{Mi}[log(NO)*NS−2*LL_{Mi}(θ)] (2)

Referencing operation 525, the BIC technique exploits the properties of the HMM, obtaining tractable forms of criteria while summarizing the common assumption of the model selection on data independence. The approach of setting a dynamic threshold via the Bayesian Information Criterion (BIC) in HMM is applied to the problem of detecting the optimal size of observations to switch from the MAB (cold start) algorithm to the HMM (preferences algorithm).

In the context of Expectation Maximization (“EM”) in the HMM algorithm, the set of unknown hidden states NS associated with a model Mi is defined as θ=(πᵢ, Aᵢ, θᵢ), where πᵢ denote the prior probabilities of the hidden process NS, Aᵢ are the Markov chain transition probabilities, θᵢ are the parameters of the conditional process X|NS, and the threshold of the EM algorithm is fixed to E=10⁻⁴.

The following algorithm illustrates the recommendation model's use of the dynamic threshold to choose between the MAB algorithm and the HMM algorithm as referenced in operations 530 and 535.

Algorithm 1 BIC-HMM Algorithm

| | |
|---|---|
| Require: | UserObservationList ≥ 0 |
| | MaxNumRecommendations ≥ 0 |

```
  range_N_hiddenStates ← [ ]
  threshold_list ← [ ]
  threshold ← 9999
  numberHiddenStates ← 5
  while (threshold > ε⁻⁴)∥(numberHiddenStates ≤ MaxNumRecommendations)
  do
    range_N_hiddenStates.add(numberHiddenStates)
    Calculate the marginal a posteriori probabilites P(SN|SO)
      using Baum-Welch algorithm - HMM(UserObservationsList)
    Calculate the BIC criterion costs [1]
    threshold ← BIC
    threshold_list.add(threshold)
    numberHiddenStates ← numberHiddenStates + (numberHiddenStates + 2)
  end while
  if (lenght(threshold_list) ≥ 0)&(Locale_Elbow = = True) then
    Return the model that maximizes the Bayesian posterior probability [2]
  else
    Return 0
  end if
```

Algorithm 1 is used to switch between the MAB algorithm and HMM algorithm from a set of user-item observations (interactions) list and a maximum number of recommendations (as set in the recommendation model depending upon the size of the conference or event). The algorithm iterates until it reaches the optimal threshold or the maximum number of the recommendations. The optimal threshold is given by an elbow method, so when it converges, and the gain is minimal, the respective model generated in the optimal threshold is chosen by equation (2). The sequence of the states will be the sequence of recommendations, considering the maximum likelihood of the states in this topology. If algorithm 1 not converge to the optimal threshold and the maximum number of recommendations is reached, algorithm 1 returns 0, meaning there is no number of observations enough to generate a list of recommendations through the HMM algorithm, and the MAB algorithm will be used to generate the recommendations.

### General Information Regarding Computing Systems

As described in connection with FIGS. 1-10, some or all of the operations described in connection with the foregoing systems and methods can be performed by computing systems such as a personal computer, a desktop computer, a computer server, or cloud computing systems. As explained previously, certain operations of the foregoing methods can be performed by a combination of computing systems. The operations described in connection with the foregoing figures can be deployed through a machine, service or engine that executes computer software, modules, program codes, and/or instructions on one or more processors.

The computing systems used in the foregoing embodiments can include typical components such as one or more processors, memories, input/output devices, and storage devices. The components of the computing systems can be interconnected, for example, by a system bus or by communication links. The components of the previously described computing systems are not exhaustive.

The one or more processors can be one or more hardware processors and can execute computer-readable instructions, such as instructions stored in a memory. The processor can be an integrated circuit, a central processing unit, a multi-core processing chip, an SoC, a multi-chip module including multiple multi-core processing chips, or other hardware processor in one or more example embodiments. The hardware processor is known by other names, including but not limited to a computer processor, a microprocessor, and a multi-core processor.

The memory can store information including computer-readable instructions and data. The memory can be cache memory, a main memory, and/or any other suitable type of memory. The memory is a non-transitory computer-readable medium. In some cases, the memory can be a volatile memory device, while in other cases the memory can be a non-volatile memory device.

The storage device can be a non-transitory computer-readable medium that provides large capacity storage for a computing system. The storage device can be a disk drive, a flash drive, a solid state device, or some other type of storage device. In some cases, the storage device can be a database that is remote from the computing system. The storage device can store operating system data, file data, database data, algorithms, and software modules, as examples.

### ASSUMPTIONS AND DEFINITIONS

For any figure shown and described herein, one or more of the components may be omitted, added, repeated, and/or substituted. Accordingly, embodiments shown in a particular figure should not be considered limited to the specific arrangements of components shown in such figure. Further, if a component of a figure is described but not expressly shown or labeled in that figure, the label used for a corresponding component in another figure can be inferred to that component. Conversely, if a component in a figure is labeled but not described, the description for such component can be substantially the same as the description for the corresponding component in another figure.

With respect to the example methods described herein, it should be understood that in alternate embodiments, certain steps of the methods may be performed in a different order, may be performed in parallel, or may be omitted. Moreover, in alternate embodiments additional steps may be added to the example methods described herein. Accordingly, the example methods provided herein should be viewed as illustrative and not limiting of the disclosure.

The term “obtaining” may include receiving, retrieving, accessing, generating, etc. or any other manner of obtaining data.

Terms such as “first” and “second” are used merely to distinguish one element (or state of an element) from another. Such terms are not meant to denote a preference and are not meant to limit the embodiments described herein. In the example embodiments described herein, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

The terms “a,” “an,” and “the” are intended to include plural alternatives, e.g., at least one. The terms “including”, “with”, and “having”, as used herein, are defined as comprising (i.e., open language), unless specified otherwise. The phrase “and/or” means either or both. Similarly, when used in a list of items, the word “or” means either or both. However, when “or” is preceded by “either” or similar terms, it shall be interpreted as meaning exclusive alternatives. The terms “including”, “with”, and “having”, as used herein, are defined as comprising (i.e., open language), unless specified otherwise.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

### EXAMPLE EMBODIMENTS

The following are example embodiments applying the techniques in the foregoing description. The following are non-limiting examples and other aspects and embodiments will be described herein. These example embodiments are not intended to limit the scope of the claimed subject matter.

Embodiment 1: A system comprising: (a) a host computing system comprising a processor, a memory, and a storage system, the storage system comprising an extended reality application and a recommendation model, the extended reality application providing an extended reality event to a client computing system, wherein the host computing system comprises computer-executable instructions that when executed cause the processor to perform operations comprising: (b) requesting, by the extended reality application from the recommendation model, a content recommendation for a user associated with the client computing system; (c) determining, by the recommendation model, whether a dynamic threshold of user data is satisfied by analyzing user data associated with the user; (d) when the dynamic threshold of user data is not satisfied, executing, by the content recommendation model, a cold start algorithm that generates a cold start content recommendation, and providing the cold start content recommendation to the extended reality application for delivery to the client computing system associated with the user; and (e) when the dynamic threshold of user data is satisfied, executing, by the content recommendation model, a preferences algorithm that generates a preferences content recommendation, and providing the preferences content recommendation to the extended reality application for delivery to the client computing system associated with the user.

Embodiment 2: The system of Embodiment 1, wherein the cold start algorithm is a multi-arm bandit algorithm and the preferences algorithm is a hidden Markov model algorithm.

Embodiment 3: The system of Embodiment 1, wherein the user data associated with the user comprises identifying data, schedule data, and prior interactions data.

Embodiment 4: The system of Embodiment 3, wherein the cold start algorithm generates the cold start content recommendation based upon a popularity of cold start content associated with the cold start content recommendation and based upon a randomizing factor, wherein the randomizing factor mitigates bias in the generation of the cold start content recommendation.

Embodiment 5: The system of Embodiment 4, wherein the operations further comprise: (a) receiving, from the client computing system, an acceptance of the cold start content recommendation; (b) delivering, by the extended reality application to the client computing system, the cold start content associated with the cold start content recommendation; and (c) updating, by the extended reality application, the user data to reflect the acceptance and delivery of the cold start content.

Embodiment 6: The system of Embodiment 3, wherein the preferences algorithm generates the preferences content recommendation based upon an analysis of a sequence of the prior interactions data and a determination of convergence of the prior interactions data.

Embodiment 7: The system of Embodiment 3, wherein the dynamic threshold of user data is determined by: (a) selecting, by the recommendation model, a criterion from one of a Bayesian criterion or an Akaike criterion; (b) calculating, by the recommendation model, posterior probabilities of unknown hidden states using a Baum-Welch algorithm; (c) calculating, by the recommendation model, a processing cost associated with the preferences algorithm; and (d) determining, by the recommendation model, whether the prior interactions data converges on an optimal number of interactions, (e) wherein, if the prior interactions data converges on an optimal number of interactions, the recommendation model selects the preferences algorithm for future content recommendations for the user, and (f) wherein, if the prior interactions data does not converge on an optimal number of interactions, the recommendation model selects the cold start algorithm for future content recommendations for the user.

Embodiment 8: A computer-implemented method for a host computing system to provide an extended reality event to a client computing system, the hosting computing system comprising an extended reality application and a recommendation model, the computer-implemented method comprising: (a) requesting, by the extended reality application from the recommendation model, a content recommendation for a user associated with the client computing system; (b) determining, by the recommendation model, whether a dynamic threshold of user data is satisfied by analyzing user data associated with the user; (c) when the dynamic threshold of user data is not satisfied, executing, by the content recommendation model, a cold start algorithm that generates a cold start content recommendation, and providing the cold start content recommendation to the extended reality application for delivery to a client computing system associated with the user; and (d) when the dynamic threshold of user data is satisfied, executing, by the content recommendation model, a preferences algorithm that generates a preferences content recommendation, and providing the preferences content recommendation to the extended reality application for delivery to the client computing system associated with the user.

Embodiment 9: The computer-implemented method of Embodiment 8, wherein the cold start algorithm is a multi-arm bandit algorithm and the preferences algorithm is a hidden Markov model algorithm.

Embodiment 10: The computer-implemented method of Embodiment 8, wherein the user data associated with the user comprises identifying data, schedule data, and prior interactions data.

Embodiment 11: The computer-implemented method of Embodiment 10, wherein the cold start algorithm generates the cold start content recommendation based upon a popularity of cold start content associated with the cold start content recommendation and based upon a randomizing factor, wherein the randomizing factor mitigates bias in the generation of the cold start content recommendation.

Embodiment 12: The computer-implemented method of Embodiment 11, further comprising: (a) receiving, from the client computing system, an acceptance of the cold start content recommendation; (b) delivering, by the extended reality application to the client computing system, the cold start content associated with the cold start content recommendation; and (c) updating, by the extended reality application, the user data to reflect the acceptance and delivery of the cold start content.

Embodiment 13: The computer-implemented method of Embodiment 10, wherein the preferences algorithm generates the preferences content recommendation based upon an analysis of a sequence of the prior interactions data and a determination of convergence of the prior interactions data.

Embodiment 14: The computer-implemented method of Embodiment 10, further comprising determining the dynamic threshold of user data by: (a) selecting, by the recommendation model, a criterion from one of a Bayesian criterion or an Akaike criterion; (b) calculating, by the recommendation model, posterior probabilities of unknown hidden states using a Baum-Welch algorithm; (c) calculating, by the recommendation model, a processing cost associated with the preferences algorithm; and (d) determining, by the recommendation model, whether the prior interactions data converges on an optimal number of interactions, (e) wherein, if the prior interactions data converges on an optimal number of interactions, the recommendation model selects the preferences algorithm for future content recommendations for the user, and (f) wherein, if the prior interactions data does not converge on an optimal number of interactions, the recommendation model selects the cold start algorithm for future content recommendations for the user.

Embodiment 15: A non-transitory computer-readable medium comprising instructions stored thereon that, when executed by one or more computer processors, cause the one or more computer processors to perform operations comprising: (a) requesting, by an extended reality application from a recommendation model, a content recommendation for a user associated with a client computing system; (b) determining, by the recommendation model, whether a dynamic threshold of user data is satisfied by analyzing user data associated with the user; (c) when the dynamic threshold of user data is not satisfied, executing, by the content recommendation model, a cold start algorithm that generates a cold start content recommendation, and providing the cold start content recommendation to the extended reality application for delivery from a host computing system to the client computing system associated with the user; and (d) when the dynamic threshold of user data is satisfied, executing, by the content recommendation model, a preferences algorithm that generates a preferences content recommendation, and providing the preferences content recommendation to the extended reality application for delivery from the host computing system to the client computing system associated with the user.

Embodiment 16: The non-transitory computer-readable medium of Embodiment 15, wherein the user data associated with the user comprises identifying data, schedule data, and prior interactions data.

Embodiment 17: The non-transitory computer-readable medium of Embodiment 16, wherein the cold start algorithm generates the cold start content recommendation based upon a popularity of cold start content associated with the cold start content recommendation and based upon a randomizing factor, wherein the randomizing factor mitigates bias in the generation of the cold start content recommendation.

Embodiment 18: The non-transitory computer-readable medium of Embodiment 17, wherein the operations further comprise: (a) receiving, from the client computing system, an acceptance of the cold start content recommendation; (b) delivering, by the extended reality application to the client computing system, the cold start content associated with the cold start content recommendation; and (c) updating, by the extended reality application, the user data to reflect the acceptance and delivery of the cold start content.

Embodiment 19: The non-transitory computer-readable medium of Embodiment 16, wherein the preferences algorithm generates the preferences content recommendation based upon an analysis of a sequence of the prior interactions data and a determination of convergence of the prior interactions data.

Embodiment 20: The non-transitory computer-readable medium of Embodiment 16, wherein the operations further comprise determining the dynamic threshold of user data by: (a) selecting, by the recommendation model, a criterion from one of a Bayesian criterion or an Akaike criterion; (b) calculating, by the recommendation model, posterior probabilities of unknown hidden states using a Baum-Welch algorithm; (c) calculating, by the recommendation model, a processing cost associated with the preferences algorithm; and (d) determining, by the recommendation model, whether the prior interactions data converges on an optimal number of interactions, (e) wherein, if the prior interactions data converges on an optimal number of interactions, the recommendation model selects the preferences algorithm for future content recommendations for the user, and (f) wherein, if the prior interactions data does not converge on an optimal number of interactions, the recommendation model selects the cold start algorithm for future content recommendations for the user.

Although embodiments described herein are made with reference to example embodiments, it should be appreciated by those skilled in the art that various modifications are well within the scope of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

What is claimed is:

1. A system comprising:
a host computing system comprising a processor, a memory, and a storage system, the storage system comprising an extended reality application and a recommendation model, the extended reality application providing an extended reality event to a client computing system, wherein the host computing system comprises computer-executable instructions that when executed cause the processor to perform operations comprising:
requesting, by the extended reality application from the recommendation model, a content recommendation for a user associated with the client computing system;
determining, by the recommendation model, whether a dynamic threshold of user data is satisfied by analyzing user data associated with the user;
when the dynamic threshold of user data is not satisfied, executing, by the content recommendation model, a cold start algorithm that generates a cold start content recommendation, and providing the cold start content recommendation to the extended reality application for delivery to the client computing system associated with the user; and
when the dynamic threshold of user data is satisfied, executing, by the content recommendation model, a preferences algorithm that generates a preferences content recommendation, and providing the preferences content recommendation to the extended reality application for delivery to the client computing system associated with the user.

2. The system of claim 1, wherein the cold start algorithm is a multi-arm bandit algorithm and the preferences algorithm is a hidden Markov model algorithm.

3. The system of claim 1, wherein the user data associated with the user comprises identifying data, schedule data, and prior interactions data.

4. The system of claim 3, wherein the cold start algorithm generates the cold start content recommendation based upon a popularity of cold start content associated with the cold start content recommendation and based upon a randomizing factor, wherein the randomizing factor mitigates bias in the generation of the cold start content recommendation.

5. The system of claim 4, wherein the operations further comprise:
receiving, from the client computing system, an acceptance of the cold start content recommendation;
delivering, by the extended reality application to the client computing system, the cold start content associated with the cold start content recommendation; and
updating, by the extended reality application, the user data to reflect the acceptance and delivery of the cold start content.

6. The system of claim 3, wherein the preferences algorithm generates the preferences content recommendation based upon an analysis of a sequence of the prior interactions data and a determination of convergence of the prior interactions data.

7. The system of claim 3, wherein the dynamic threshold of user data is determined by:
selecting, by the recommendation model, a criterion from one of a Bayesian criterion or an Akaike criterion;
calculating, by the recommendation model, posterior probabilities of unknown hidden states using a Baum-Welch algorithm;
calculating, by the recommendation model, a processing cost associated with the preferences algorithm; and
determining, by the recommendation model, whether the prior interactions data converges on an optimal number of interactions,
wherein, if the prior interactions data converges on an optimal number of interactions, the recommendation model selects the preferences algorithm for future content recommendations for the user, and
wherein, if the prior interactions data does not converge on an optimal number of interactions, the recommendation model selects the cold start algorithm for future content recommendations for the user.

8. A computer-implemented method for a host computing system to provide an extended reality event to a client computing system, the hosting computing system comprising an extended reality application and a recommendation model, the computer-implemented method comprising:
requesting, by the extended reality application from the recommendation model, a content recommendation for a user associated with the client computing system;
determining, by the recommendation model, whether a dynamic threshold of user data is satisfied by analyzing user data associated with the user;
when the dynamic threshold of user data is not satisfied, executing, by the content recommendation model, a cold start algorithm that generates a cold start content recommendation, and providing the cold start content recommendation to the extended reality application for delivery to a client computing system associated with the user; and
when the dynamic threshold of user data is satisfied, executing, by the content recommendation model, a preferences algorithm that generates a preferences content recommendation, and providing the preferences content recommendation to the extended reality application for delivery to the client computing system associated with the user.

9. The computer-implemented method of claim 8, wherein the cold start algorithm is a multi-arm bandit algorithm and the preferences algorithm is a hidden Markov model algorithm.

10. The computer-implemented method of claim 8, wherein the user data associated with the user comprises identifying data, schedule data, and prior interactions data.

11. The computer-implemented method of claim 10, wherein the cold start algorithm generates the cold start content recommendation based upon a popularity of cold start content associated with the cold start content recommendation and based upon a randomizing factor, wherein the randomizing factor mitigates bias in the generation of the cold start content recommendation.

12. The computer-implemented method of claim 11, further comprising:
receiving, from the client computing system, an acceptance of the cold start content recommendation;
delivering, by the extended reality application to the client computing system, the cold start content associated with the cold start content recommendation; and
updating, by the extended reality application, the user data to reflect the acceptance and delivery of the cold start content.

13. The computer-implemented method of claim 10, wherein the preferences algorithm generates the preferences content recommendation based upon an analysis of a sequence of the prior interactions data and a determination of convergence of the prior interactions data.

14. The computer-implemented method of claim 10, further comprising determining the dynamic threshold of user data by:
selecting, by the recommendation model, a criterion from one of a Bayesian criterion or an Akaike criterion;
calculating, by the recommendation model, posterior probabilities of unknown hidden states using a Baum-Welch algorithm;
calculating, by the recommendation model, a processing cost associated with the preferences algorithm; and
determining, by the recommendation model, whether the prior interactions data converges on an optimal number of interactions,
wherein, if the prior interactions data converges on an optimal number of interactions, the recommendation model selects the preferences algorithm for future content recommendations for the user, and
wherein, if the prior interactions data does not converge on an optimal number of interactions, the recommendation model selects the cold start algorithm for future content recommendations for the user.

15. A non-transitory computer-readable medium comprising instructions stored thereon that, when executed by one or more computer processors, cause the one or more computer processors to perform operations comprising:
requesting, by an extended reality application from a recommendation model, a content recommendation for a user associated with a client computing system;
determining, by the recommendation model, whether a dynamic threshold of user data is satisfied by analyzing user data associated with the user;
when the dynamic threshold of user data is not satisfied, executing, by the content recommendation model, a cold start algorithm that generates a cold start content recommendation, and providing the cold start content recommendation to the extended reality application for delivery from a host computing system to the client computing system associated with the user; and
when the dynamic threshold of user data is satisfied, executing, by the content recommendation model, a preferences algorithm that generates a preferences content recommendation, and providing the preferences content recommendation to the extended reality application for delivery from the host computing system to the client computing system associated with the user.

16. The non-transitory computer-readable medium of claim 15, wherein the user data associated with the user comprises identifying data, schedule data, and prior interactions data.

17. The non-transitory computer-readable medium of claim 16, wherein the cold start algorithm generates the cold start content recommendation based upon a popularity of cold start content associated with the cold start content recommendation and based upon a randomizing factor, wherein the randomizing factor mitigates bias in the generation of the cold start content recommendation.

18. The non-transitory computer-readable medium of claim 17, wherein the operations further comprise:
receiving, from the client computing system, an acceptance of the cold start content recommendation;
delivering, by the extended reality application to the client computing system, the cold start content associated with the cold start content recommendation; and
updating, by the extended reality application, the user data to reflect the acceptance and delivery of the cold start content.

19. The non-transitory computer-readable medium of claim 16, wherein the preferences algorithm generates the preferences content recommendation based upon an analysis of a sequence of the prior interactions data and a determination of convergence of the prior interactions data.

20. The non-transitory computer-readable medium of claim 16, wherein the operations further comprise determining the dynamic threshold of user data by:
selecting, by the recommendation model, a criterion from one of a Bayesian criterion or an Akaike criterion;
calculating, by the recommendation model, posterior probabilities of unknown hidden states using a Baum-Welch algorithm;
calculating, by the recommendation model, a processing cost associated with the preferences algorithm; and
determining, by the recommendation model, whether the prior interactions data converges on an optimal number of interactions,
wherein, if the prior interactions data converges on an optimal number of interactions, the recommendation model selects the preferences algorithm for future content recommendations for the user, and
wherein, if the prior interactions data does not converge on an optimal number of interactions, the recommendation model selects the cold start algorithm for future content recommendations for the user.
